(19) United States
(12) Patent Application Publication
(10) Pub. No.: US 2014/0118149 A1
(43) Pub. Date: May 1, 2014

(54) LOCATION AND NOTIFICATION TRACKING SYSTEM

(71) Applicant: John Elias, Patashkala, OH (US)

(72) Inventor: John Elias, Patashkala, OH (US)

(21) Appl. No.: 13/950,889

(22) Filed: Jul. 25, 2013

Related U.S. Application Data
(60) Provisional application No. 61/720,597, filed on Oct. 31, 2012.

(51) Int. Cl. G08B 21/02

(52) U.S. Cl. CPC G08B 21/0261
USPC 340/573.4

(57) ABSTRACT

A location and notification tracking system includes at least one transmitter carried by a person for transmitting location data signals corresponding to the location of the at least one transmitter. A tracing application software provided on one or more communication devices sets operational parameters corresponding to boundaries in which the individual is free to move about. A data server receives the data signals from the one or more communication devices corresponding to the operational parameters set in the tracing application software. The data server receives the location data signals from the at least one transmitter and sends alert signals to the one or more communication devices when the at least one transmitter is outside of the operational boundaries set on the tracing application software.

### TECHNICAL FIELD OF THE INVENTION

The present invention is directed to a system for locating a person and notifying of their location and more particularly to a system for locating when a person goes beyond preset boundaries and notifying another through a communication device of this occurrence.

### BACKGROUND OF THE INVENTION

Children in this country and throughout the world are being unlawfully abducted at an increasing rate. In the United States each year, thousands of children are abducted or lost at public venues. Unfortunately, the problem of protecting children from abduction has been with us a long time and is a very difficult problem to solve. Presently, there is no readily available method of keeping track of the location of a child at all times when they are away from home. Additionally, the police normally require that a child be missing for 24 hours before they will get involved absent a ransom note, for example.

The safety and welfare of children takes the utmost priority in the lives of most people. There have been attempts by others to devise various devices that are aimed at preventing or inhibiting the abduction of children, The public has been turning to technology more and more to protect children and to prevent their abduction, injury and harm. It is a worry for many parents and for the authorities that it can be difficult to locate children who stray from or are removed from their parents' direct supervision and control. In the most innocent case, a child may simply stray and become lost. In more sinister circumstances, the child may be abducted. In either case there is a need to be able to locate the child quickly and positively.

### SUMMARY OF THE INVENTION

According to the present invention, a location and notification tracking system includes at least one transmitter carried by a person for transmitting location data signals corresponding to the location of the at least one transmitter. A tracing application software provided on one or more communication devices is used for setting operational parameters corresponding to boundaries in which the individual is free to move about. A data server receives the data signals from the one or more communication devices corresponding to the operational parameters set in the tracing application software. The data server receives the location data signals from the at least one transmitter and sends alert signals to the one or more communication devices when the at least one transmitter is outside of the operational boundaries set on the tracing application software.

Further according to the present invention, a method of locating and tracking a person includes: carrying at least one transmitter by the person for transmitting location data signals corresponding to the location of the at least one transmitter; setting operational parameters of application software provided on one or more communication devices corresponding to boundaries in which the person is free to move about; receiving data signals corresponding to the operational parameters set in the tracing application software; setting operational parameters from the one or more communication devices corresponding to the operational parameters set in the tracing application software; and receiving the location data signals from the at least one transmitter and sending alert signals to the one or more communication devices when the at least one transmitter is outside of the operational boundaries set on the tracing application software.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

FIG. 1 is a schematic view of the child location and notification tracking system, in accordance with the present invention.

FIG. 2a is a front view of a transmitter disguised within a charm on a bracelet, for use with the child location and notification tracking system, in accordance with the present invention.

FIG. 2b is a front view of a transmitter disguised within a crown of a wristwatch, for use with the child location and notification tracking system, in accordance with the present invention.

FIG. 2c is a front view of a transmitter disguised within a medallion of a necklace, for use with the child location and notification tracking system, in accordance with the present invention.

FIG. 2d is a front view of a transmitter disguised within an earring, for use with the child location and notification tracking system, in accordance with the present invention.

FIG. 3 is a flow chart of the interconnection of the components of the transmitter for use with the child location and notification tracking system, in accordance with the present invention.

FIG. 3a is a flow chart of an alternative embodiment of the interconnection of the components of the transmitter for use with the child location and notification tracking system, in accordance with the present invention.

FIG. 4 is a flow chart of the steps required for using the tracing application software of the child location and notification tracking system, in accordance with the present invention.

FIG. 5 is a flow chart of the steps required for using the data server of the child location and notification tracking system, in accordance with the present invention.

FIG. 6 is a front three dimensional view of the child location and notification tracking system in normal operation, in accordance with the present invention.

FIG. 7 is a front three dimensional view of the child location and notification tracking system in operation alerting a subscriber, in accordance with the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader, and should not in any way be interpreted as limiting.

There is a grave need for personal safety and security in today's society. All too often, there are reports and stories of missing persons and the dramatic searches that ensue. There is a recognized need for improved personal security and emergency response capability. In situations where an individual is injured, lost, or abducted, immediate notification of an emergency situation to a local law enforcement or emergency response organization is required to maintain the safety of the individual and to avoid tragic circumstances.

The child location and notification tracking system 10 (hereafter “tracking system”) is a response to these dangers. The tracking system 10 utilizes a mobile device to assist in capturing and transmitting critical information from the victim to persons who can provide the best chances of help. In general terms, the tracking system 10 employs children accessories to contain one or more concealed transmitters 12. Further, a tracing app 40 to be used in conjunction with smart phones and other mobile communications devices 16, will have the capability of actually tracing the tracking devices, alerting the parent or guardian and directly contacting local authorities.

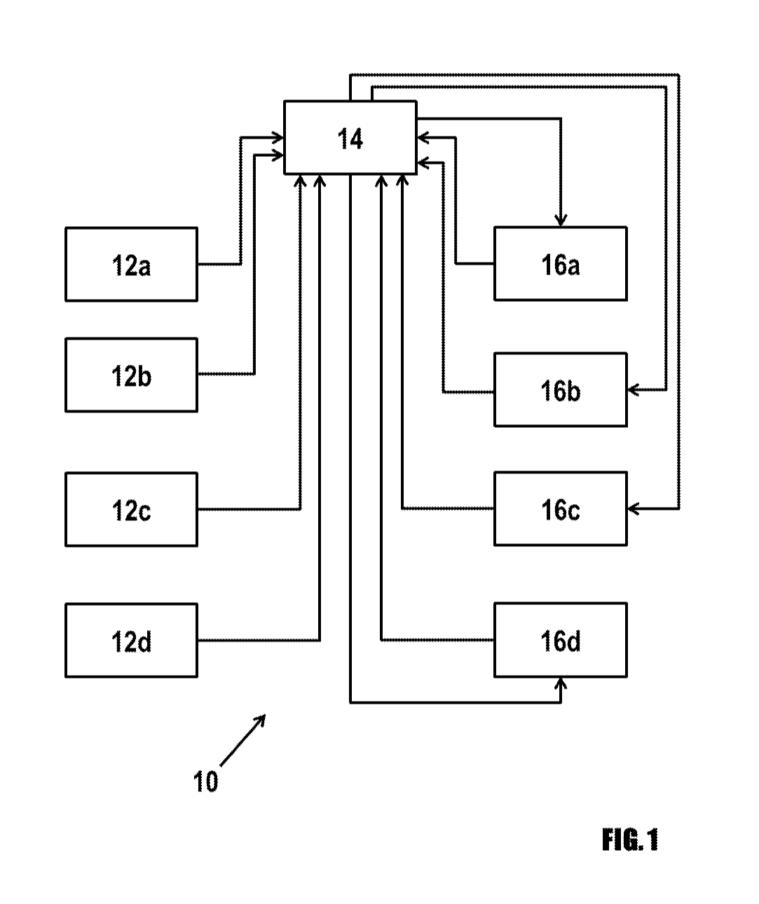

FIG. 1 illustrates an overall schematic view of the tracking system 10. The tracking system functions utilizing a plurality of transmitters 12, including any number such as 12a, 12b, 12c, and 12d (12a-12d), which uplink locational information to a data server 14, that is interconnected with a plurality of mobile communications devices 16, including any number such as 16a, 16b, 16c, and 16d (16a-16d).

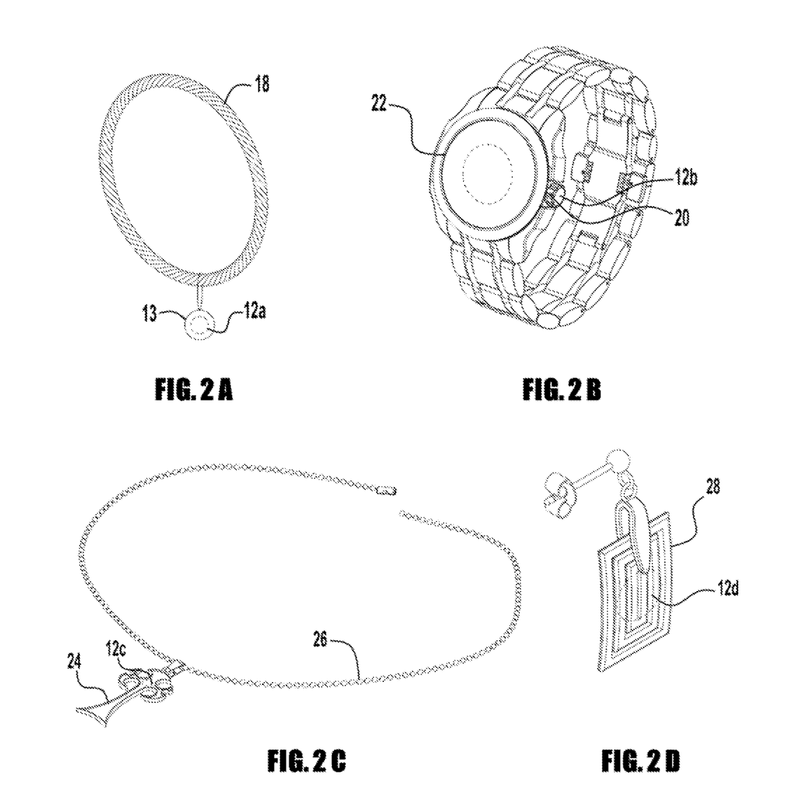

FIGS. 2a, and 2d illustrate a variety of exemplary transmitters 12a-12d. FIG. 2a illustrates transmitter 12a disguised within a charm 13 on a bracelet 18. FIG. 2b illustrates a transmitter 12b disguised within the crown 20 of a wristwatch 22. FIG. 2c illustrates transmitter 12c disguised within a medallion 24 of a necklace 26. FIG. 2d illustrates a transmitter 12d disguised within an earring 28. However, it is within the terms of the embodiment that the transmitter 12 may also be concealed within any appropriate articles of clothing, shoes, coats, rings or any other suitable disguise. For example, the transmitter may also be disguised within a hair accessory, such as a child's beret. It is within the terms of the embodiment that the transmitter 12 be transferred between different disguises. For example, there may be a magnet attached to each transmitter 12 such that the transmitter be easily removed from one disguise, and attached to another disguise. It is envisioned that the individual sought to be tracked would wear more than one transmitter 12, such that should one be discovered, or malfunction, there are other transmitters to be monitored.

The shape of the transmitter 12 is primarily dictated by the physical shape of the desired item in which the transmitter be concealed, such as bracelet 18. While the transmitter 12 is shown as a circular disc, the specific shape is not intended to be a limiting factor and any desired and appropriate shape can be used. The enclosure of the transmitter 12 is envisioned to be of injection molded plastic with appropriate seals to allow its use under wet conditions. The size of the transmitter 12 may be of any desired size. However, as technology continues to advance and miniaturize, it is envisioned that the size of the transmitter 12 may decrease.

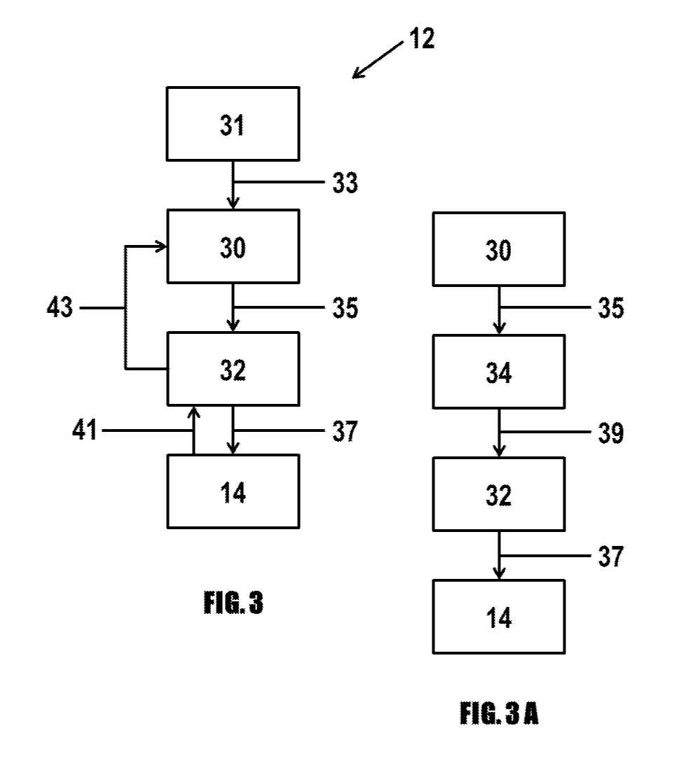

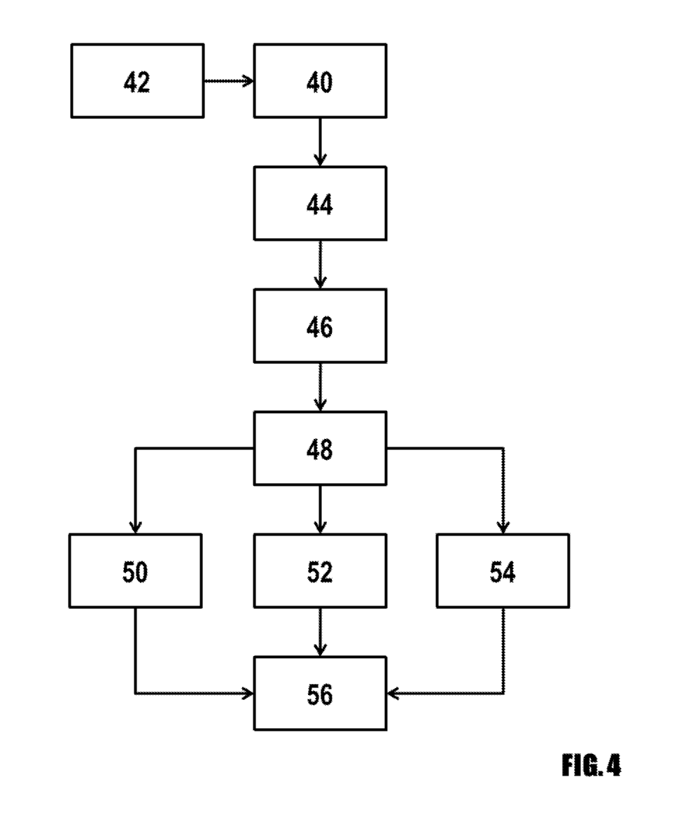

FIG. 3 illustrates the components of the transmitter 12. The transmitter 12 includes a location determining device 30 (e.g., a GPS receiver) operative to receive signals 33 from a positioning system 31, such as a satellite, and to generate location data signals 35 based on the signals 33. Further, the transmitter 12 includes a data transceiver 32 which receives location data signals 35 and is operable to transmit a data signal 37 to the data server 14.

In an alternative embodiment, as shown in FIG. 3a, the transmitter 12 may include a wireless communication device 34 which receives the location data signals 35 from the location determining device 30 and transmits corresponding data signals 39 to the data transceiver 32 which in turn transmits the data signal 37 to the data server 14.

As discussed herein after, the data transceiver 32 is also operative to receive control data 41 from the data server 14 specifying operational parameters for the transmitter 12 and to direct a signal 43 corresponding to the control data 41 to the location determining device 30. There is a battery (not shown) to power the transmitter 12, and it is within the terms of the embodiment that there be an inductive charging component (not shown) coupled to charge the battery.

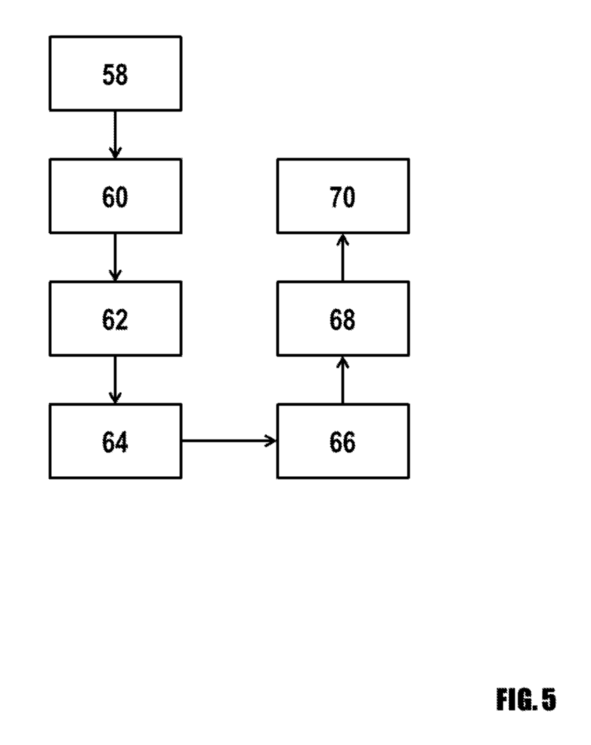

Referring to FIG. 4, tracking system 10 incorporates tracing application software 40 (a tracing app), designed to be downloaded to a mobile communications device 16, as shown in FIG. 1) by subscribers 42. Subscribers 42 represent individuals with an interest in the location of the person wearing the transmitters 12. For example, tracking system 10 can be used by parents to locate children, by service departments to locate emergency service personal in the field, and so on. Subscribers 42 communicate with the data server 14 utilizing the mobile communications device 16.

The mobile communications device 16 can be a cell phone, smartphone, computer, PDA, or other mobile communications device capable of sending and receiving data over a wireless network, including, for example, an Apple iPhone® or iPad®, a Blackberry® or Android® smartphone, etc. The mobile communications device 16 allows the individual to interact with the data server 14. Each mobile communications device 16 may include a processor, network interface circuitry, and memory. The mobile communications device 16 is connected to a wireless network, such as a commercial cellular data network, WiFi, or a WAN network. The operation of these various communication networks are well known and will not be described in greater detail.

Referring again to FIG. 4, in step 44, the subscriber 42 must first download the tracing app 40 to the mobile communications device 16, which are devices through which tracking system 10 users interact with the data server 14. The tracing app 40 operates on a mobile software platform such as iPhone OS, Android OS, Palm WebOS, J2ME, Windows Mobile, Flash, Flash Mobile, or other similar mobile software platform. In its operative configuration, the tracing app 40 is stored and operates on the mobile communications device 16. The tracing app 40 may be loaded onto the user device either through a wired or wireless connection, such as via download from a remote storage location, like a server hosting a site with multiple applications, that are downloaded by users.

In step 46, the subscriber 42 creates an account within the tracing app 40, to dictate various operational parameters of the transmitters 12. While the subscriber 42 typically creates the account on the data server 14 through their mobile communications device 16, it is also within the preferred embodiment to create an account directly on the data server 14 through a website associated with the tracking system 10. The website may provide a portal to each subscriber 42 to review their profile and their parameters that they have set.

In step 48, the user 42 selects from a variety of potential settings within the tracing app 40.

Step 50 illustrates one potential setting, in which the subscriber 42 sets the location parameters for which the individual being tracked may go. For example, the subscriber 42 may set the location parameters to include the boundaries of a store. If the transmitters 12 detect that the individual has left the boundaries of the store, the subscriber 42 will be notified. The location parameters may also include a distance boundary. For example, should the individual being tracked leave a one mile radius, the subscriber 42 will be notified.

Step 52 illustrates the setting in which the subscriber 42 selects the frequency in which the transmitters 12 are being updated with their locations. For example, the subscriber 42 may select that the transmitters 12 update their locations every two minutes.

Step 54 illustrates the setting in which the subscriber 42 selects a time parameter for the transmitters 12. For example, the subscriber 42 may select that the transmitters are only functional on Tuesday between 2:00 PM and 8:00 PM.

It is within the terms of the embodiment that any desired operational parameters be applied to the transmitters 12 for operation of the tracking system 10.

In step 56, after the desired operational parameters have been selected by the subscriber 42, these are stored in the tracing app 40 and uplinked to the data server 14.

Referring to FIG. 5, there is a flow chart showing the operation of the data server 14. The data server 14 is a network-connected server computer system or set of computer systems that provides various types tracking and reporting and is interconnected between the transmitters 12 and the tracing app 40 established by the subscriber 40 of the tracking system 10. The data server 14 can be hosted by a web server or server farm, and offers account access and tracking of the transmitters 12 for the subscriber 42.

As described in regards to FIG. 5, all of the operational parameters have been selected by the subscriber 42.

In step 58, the transmitters 12 monitor their locations in response to the operational parameters as set by the subscriber 42. The transmitters 12 are responsive to the commands from the data server 12. Transmitters 12 utilizes a location determining device 30 which may include any type of satellite or terrestrial based positioning system that transmits signals that can be used to determine location. For example, a global positioning system (GPS) employs a plurality of satellites that continuously transmit signals. UPS receivers can calculate location by determining the difference in the time of receipt of signals from different satellites. GPS technology is well known, and so will not be described in detail herein.

As an alternative to a GPS type system, the positioning system can be incorporated into a wireless communication link. For example, wireless telephone networks now have the capability of determining the location of mobile telephone handsets based on signals from a plurality of signal towers in the network.

The position location ay be transmitted intermittently (such as every 30 seconds or when a change in location above a threshold distance is determined) or continuously, thereby providing a data log of the device's changing position so as to track the movement of the phone. This is a setting that also may be chosen by the subscriber 42.

In step 60, the transmitters 12 determine their location using location signals received from the location determining device 30. The wireless data transceiver 32 transmits the data indicative of the determined location back to the data server 14.

In step 62, the data server 14 interacts with the tracing app 40 to relay the location of the transmitters 12. This is to allow the subscriber 42 to have the ability of always monitoring the location of the individual being tracked with the transmitters 12. The subscriber 42 will have the option of monitoring the location of the transmitters 12 on the tracing app 40, utilizing for example the mapping function on the iPhone. Alternatively, the subscriber 42 may monitor the location of the transmitters 12 on a website.

In step 64, the individual being monitored has acted to alert the data server that an operational parameter as set by the subscriber 42 has been violated. For example, one or more of the transmitters 12 have been removed from the locations as defined by the subscriber 42 in step 50 of FIG. 4.

In step 66, the transmitter 12 responds to the control data, as described in FIG. 3, and alerts the data server 14 that an operational parameter has been violated.

In step 68, the data server 14 alerts the subscriber 42 that an operational parameter has been violated. This alert signal may include an automatic phone call to the subscriber, an alert email, a text message to the mobile communications device 16, or any other appropriate alerting mechanism. The alert signal data may contain the date and time that the operational parameter was violated, a predetermined message with help request, a link to and/or image of Google Maps, Yahoo Maps or other digital map with user's most recent location and may include depictions of past locations since the transmitter 12 had been active, the most recent GPS coordinates of the transmitter, such as street address (as determined from the GPS coordinates if possible), latitude, longitude, altitude, and speed, and any other desired information.

In step 70, the data server 14 sends an alert to emergency responders, such as the police. This alert signal may include a phone call, an alert email, a text message 6, or any other appropriate alerting mechanism. The alert signal data may contain the date and time that the operational parameter was violated, a predetermined message with help request, a link to and/or image of Google Maps, Yahoo Maps or other digital map with user's most recent location and may include depictions of past locations since the transmitter 12 had been active, the most recent GPS coordinates of the transmitter, such as street address (as determined from the GPS coordinates if possible), latitude, longitude, altitude, and speed, and any other desired information.

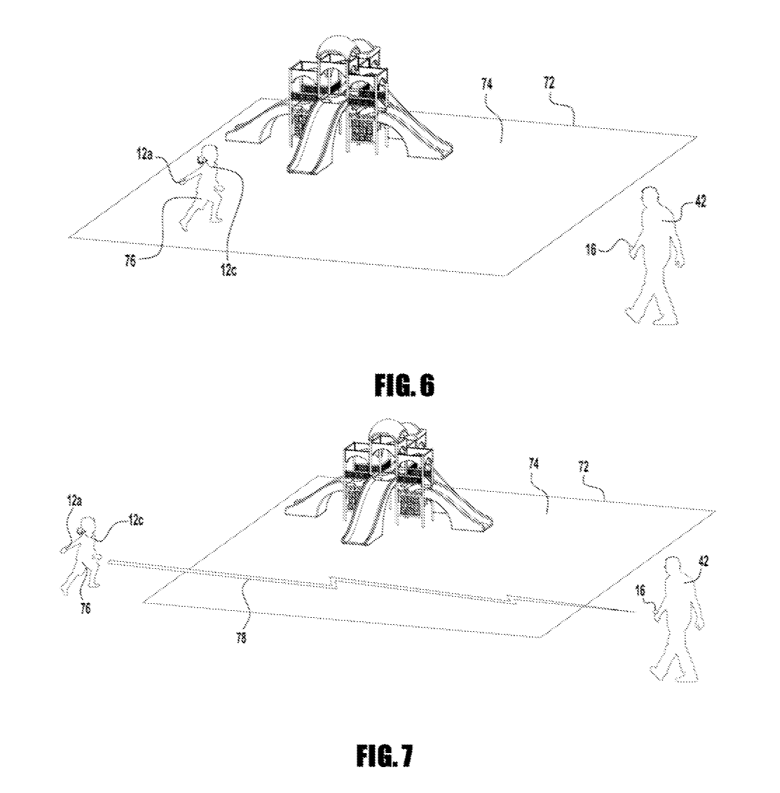

Referring to FIG. 6, there is illustrated the tracking system 10 in operation. As illustrated, subscriber 42 has set an operational parameter 72 of the boundaries of a playground 74. He has created the operational parameter 72 with the mobile communications device 16, utilizing tracing app 40, as described in FIG. 4. A child 76 is wearing transmitters 12a and 12c, as shown in FIGS. 2a and 2b, respectively. The subscriber 42 may track the movement of transmitters 12a and 12c on the tracing app 40 of his mobile communications device 16. Referring to FIG. 7, the operational parameter 72 of the boundaries of a playground 74 has been set by the subscriber 42. Here, however, the child 76 has vacated the operational parameter 72, and the transmitters 12a and 12c have responded. They sent an alert 78 to the mobile communications device 16 of the subscriber 42, alerting him that the transmitters have been removed for the operational parameter 72.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A location and notification tracking system, comprising:
at least one transmitter carried by a person for transmitting location data signals corresponding to the location of the at least one transmitter;
tracing application software provided on one or more communication devices for setting operational parameters corresponding to boundaries in which the individual is free to move about;
a data server receiving the data signals from the one or more communication devices corresponding to the operational parameters set in the tracing application software; and
the data server receiving the location data signals from the at least one transmitter and sending alert signals to the one or more communication devices when the at least one transmitter is outside of the operational boundaries set on the tracing application software.

2. The location and notification tracking system of claim 1 wherein the at least one transmitter receives positioning signals from a positioning system.

3. The location and notification tracking system of claim 2 wherein the positioning system is a satellite.

4. The location and notification tracking system of claim 1 wherein the one or more communication devices are mobile communication devices.

5. The location and notification tracking system of claim 1 wherein the tracing application software sets an operational parameter from the group consisting essentially of the boundaries in which the individual is free to move about; the frequency in which the transmitters are being updated with their locations; and a time parameter for when the transmitters are functional.

6. The location and notification tracking system of claim 1 wherein the data server sends an alert signal when an operational parameter has been violated, the alert signals selected from the group consisting essentially of an automatic phone call, an alert email, and a text message to the communications device.

7. The location and notification tracking system of claim 6 wherein the alert signal data is selected from the group consisting of the date and time that the operational parameter was violated, a predetermined message with help request, a link to a digital map with transmitter's most recent location, and the most recent GPS coordinates of the transmitter.

8. The location and notification tracking system of claim 1 wherein at least one transmitter is embedded so as to disguise its existence.

9. The location and notification tracking system of claim 8 wherein at least one transmitter is embedded in a wristwatch.

10. The location and notification tracking system of claim 8 wherein at least one transmitter is embedded in a bracelet.

11. The location and notification tracking system of claim 8 wherein at least one transmitter is embedded in a necklace.

12. The location and notification tracking system of claim 8 wherein at least one transmitter is embedded in an earring.

13. A method of locating and tracking a person, comprising:
carrying at least one transmitter by the person for transmitting location data signals corresponding to the location of the at least one transmitter;
setting operational parameters of application software provided on one or more communication devices corresponding to boundaries in which the person is free to move about;
receiving data signals corresponding to the operational parameters set in the tracing application software;
setting operational parameters from the one or more communication devices corresponding to the operational parameters set in the tracing application software; and
receiving the location data signals from the at least one transmitter and sending alert signals to the one or more communication devices when the at least one transmitter is outside of the operational boundaries set on the tracing application software.

14. The method of claim 13 including receiving positioning signals from a positioning system on the at least one transmitter.

15. The method of claim 14 including receiving positioning signals from a satellite on the at least one transmitter.

16. The method of claim 15 including selecting the one or more communication devices from mobile communication devices.

17. The method of claim 13 including setting an operational parameter from the group consisting essentially of the boundaries in which the individual is free to move about; the frequency in which the transmitters are being updated with their locations; and a time parameter for when the transmitters are functional.

18. The method of claim 13 including selecting alert signals from the group consisting essentially of an automatic phone call, an alert email, and a text message to the communications device.

19. The method of claim 13 including selecting alert signal data from the group consisting of the date and time that the operational parameter was violated, a predetermined message with help request, a link to a digital map with transmitter's most recent location, and the most recent GPS coordinates of the transmitter.

20. The method of claim including embedding at least one transmitter so as to disguise its existence.
